(19) United States
(12) Patent Application Publication
(10) Pub. No.: US 2015/0073682 A1
(43) Pub. Date: Mar. 12, 2015

(54) DIAGNOSTIC METHOD AND APPARATUS FOR AN INTERNAL COMBUSTION ENGINE

(71) Applicant: Yoshiyasu Ito, Toyota-shi (JP)

(72) Inventor: Yoshiyasu Ito, Toyota-shi (JP)

(73) Assignee: TOYOTA JIDOSHA KABUSHIKI KAISHA, Toyota-shi, Aichi-ken (JP)

(21) Appl. No.: 14/348,312

(22) PCT Filed: May 14, 2013
(86) PCT No.: PCT/IB2013/001046

§ 371 Date: Mar. 28, 2014

(30) Foreign Application Priority Data
May 17, 2012 (JP) 2012/113395

(51) Int. Cl. F02D 41/32; F02D 41/14

(52) U.S. Cl. CPC F02D 41/32; F02D 41/14
USPC 701/104

(57) ABSTRACT

A microcomputer determines, in a first monitoring routine, whether a required injection amount was normally computed in a fuel injection amount control routine, based on the required injection amount computed in the fuel injection amount control routine, and detected values of engine operating conditions used for computation of the required injection amount in the routine, and determines, in a second monitoring routine, whether an injector was normally driven based on the required injection amount, based on the required injection amount computed in the fuel injection amount control routine, and a measurement result of a current application period of injector drive current.

### BACKGROUND OF THE INVENTION

1. Field of the Invention

The invention relates to a monitoring device of an engine control unit, which monitors whether fuel injection amount control is normally performed by an engine control unit, and also relates to a monitoring method thereof.

2. Description of Related Art

In an engine installed on a vehicle, for example, the fuel injection amount is controlled so that engine output or power is controlled according to a driver's request, etc. The fuel injection amount control of the engine is performed by an engine control unit. The engine control unit includes a microcomputer that performs computations, and an electronic drive unit (EDU) that drives injectors.

In the fuel injection amount control, the microcomputer computes a required injection amount, based on detected values of accelerator operation amount, engine speed, and so forth. Then, the microcomputer computes a current application period of injector drive current required for injecting fuel in an amount corresponding to the computed required injection amount, and sends a command indicative of the current application period to the EDU. The EDU passes drive current through injectors for the commanded current application period, so that an appropriate amount of fuel commensurate with the engine operating conditions is injected and supplied into the engine.

Some types of monitoring devices for monitoring abnormalities in the fuel injection amount control system of the engine have been proposed. For example, a monitoring device that monitors or determines whether a failure is present in the EDU, based on a current value of injector drive current measured when a valve of each injector is opened and while the injector valve is kept opened, is described in Japanese Patent Application Publication No. 11-190247 (JP 11-190247 A), for example. A monitoring device that obtains the amount of actually injected fuel, from the amount of increase of the engine speed after fuel injection, and monitors or determines whether a failure is present in the injectors, based on a deviation of the actually injected fuel amount from the commanded amount, is described in Japanese Patent Application Publication No. 2008-309077 (JP 2008-309077 A). A monitoring device that measures a current application period of injector drive current, and determines whether a failure is present in the EDU, by comparing a current application period of drive current as a command from the microcomputer to the EDU, with the measurement result, is described in Japanese Patent Application Publication No. 2003-120387 (JP 2003-120387 A).

If the computations of the microcomputer are not normally performed, and the required injection amount and/or the current application period of drive current is/are not correctly computed, the fuel injection amount control may not be normally performed even if the EDU and the injectors operate normally. In this case, too, the EDU and the injectors operate according to commands of the microcomputer; therefore, it may be determined that “there is no abnormality” in the EDU and injectors.

Thus, it is also necessary to monitor the presence or absence of an abnormality in the computing function of the microcomputer. The presence of such an abnormality may be determined in the following manner, for example. (1) A monitoring system computes a current application period, independently of a fuel injection amount control system, using parameters (engine speed, engine load, etc.) used by the fuel injection amount control system for computation of the current application period, and the results of computation of the current application periods obtained by the fuel injection amount control system and the monitoring system are compared with each other. (2) By using the result of computation of the current application period obtained by the fuel injection amount control system, the monitoring system inversely calculates parameters used for the computation, and compares the results of the calculation with the parameters actually used by the fuel injection amount control system for computation of the current application period.

In order to strictly perform the monitoring as described above, the monitoring system needs to perform computations equivalent to those performed by the fuel injection amount control system. In this connection, the computation logic for the fuel injection amount control is complicated, and requires a high computational load. Therefore, it is realistic or practical for the monitoring system to perform computations for the monitoring as described above, using a computation logic that is more simplified than the computation logic used by the fuel injection amount control system for calculation of the current application period, so as to suppress increase of the computational load.

However, if the computation logic of the monitoring system is simplified, a deviation of the computation result due to a difference between the computation logics may be increased. Therefore, it may be difficult to assure sufficiently high abnormality detection accuracy.

### SUMMARY OF THE INVENTION

The invention provides a monitoring system of an engine control unit, which can determine, with high accuracy, whether fuel injection amount control is normally performed, without significantly increasing a computational load.

According to a first aspect of the invention, there is provided a monitoring device of an engine control unit, for monitoring an abnormality in the engine control unit that computes a required injection amount from a detected value of an engine operating condition, and drives an injector based on the required injection amount so as to control a fuel injection amount, which monitoring device includes a first abnormality determining unit that makes a determination as to whether the required injection amount was normally computed by the engine control unit, based on the required injection amount computed by the engine control unit, and the detected value of the engine operating condition used for computation of the required injection amount, and a second abnormality determining unit that makes a determination as to whether the injector was normally driven based on the required injection amount; based on the required injection amount computed by the engine control unit and a driven status of the injector. In the engine control unit of the invention, when the fuel injection amount is controlled, the required injection amount is computed based on detected values of engine operating conditions, such as the accelerator operation amount and the engine speed, and driving control of the injector is performed based on the computation result of the required injection amount. Also, in the monitoring device of the invention, an abnormality in the operation of the engine control unit to compute the required injection amount is monitored by the first abnormality determining unit, and an abnormality in the operation of the engine control unit to drive the injector is monitored by the second abnormality determining unit.

With the above arrangement, control operations of the engine control unit associated with the fuel injection amount control are divided into two sets of operations, which are individually or separately monitored. Therefore, even if the computation logic of the monitoring device for abnormality determination is simplified, a computation error involved in each monitoring operation of the monitoring device is reduced, and the abnormality detection accuracy is less likely to be or prevented from being deteriorated. Accordingly, the monitoring device of the engine control unit according to the invention is able to determine, with high accuracy, whether the fuel injection amount control is normally performed, without significantly increasing the computational load.

In the monitoring device as described above, a fail-safe operation may be performed, in an engine to which the monitoring device is applied, in a first manner when an abnormality is detected by the first abnormality determining unit, and a fail-safe operation may be performed in the engine in a second manner different from the first manner when an abnormality is detected by the second abnormality determining unit. In this case, it can be determined whether an abnormality of the engine control unit associated with the fuel injection amount control occurred during a process of computing the required injection amount, or during a process of driving the injector based on the required injection amount. With this arrangement, a more appropriate fail-safe operation can be performed depending on the location where the abnormality occurred.

In the monitoring system as described above, the second abnormality determining unit may obtain the driven status of the injector from a measurement result of a current application period for which drive current is applied to the injector, so as to make the determination. In this case, the second abnormality determining unit determines the presence or absence of an abnormality in the function of the engine control unit to compute the current application period, and an abnormality in the function of producing drive current based on the computation result. If it is only required to determine the presence or absence of an abnormality in the function of the engine control unit to compute the current application period, the determination may be made by obtaining a driven status of the injector, from a value of the current application period of the drive current, which is computed by the engine control unit.

In the monitoring device as described above, the second abnormality determining unit may acquire start and ending times of application of the drive current, respectively, so as to make the above-described determination, and makes the determination and performs computation for the determination, at different points in time (timings) from points in time (timings) at which the start and ending times are acquired. With this arrangement, the concentration of operations can be eased or avoided, and the peak load of the monitoring device can be suppressed or reduced.

The pressure of the fuel supplied to the injector varies depending on engine operating conditions, such as the engine speed and the engine load. If the supply pressure of the fuel changes, the amount of fuel to be injected changes even if the drive current is applied to the injector for the same period of time. In the monitoring device as described above, the engine control unit may compute the current application period while making correction according to a pressure of fuel supplied to the injector, and the second abnormality determining unit may make the above-described determination, referring to the pressure of the fuel. With this arrangement, an abnormality can be determined with improved, accuracy.

In the monitoring device as described above, the second abnormality determining unit may acquire start and ending times of application of the drive current, respectively, so as to make the determination, and may acquire the pressure of the fuel at the same time that either of the start and ending times of current application is acquired. With this arrangement, the number or frequency of interrupts in processing for acquiring data can be prevented from increasing, and other operations are less likely to be or prevented from being delayed due to the interrupts.

Since there are individual differences in injection characteristics of the injectors, the current application period of the driving current may be computed, while being corrected with an individual difference correction value for compensating for the individual differences in the injection characteristics of the injectors. In the monitoring device as described above, the engine control unit may compute the current application period while making correction using an individual difference correction value for compensating for an individual difference in an injection characteristic of the injector, and the second abnormality determining unit may refer to the individual difference correction value when making the determination. With this arrangement, an abnormality can be determined with improved accuracy.

In the monitoring device as described above, the engine control unit may compute the required injection amount while making correction in terms of an engine coolant temperature, and the first abnormality determining unit may refer to the engine coolant temperature when making the determination. With this arrangement, an abnormality can be determined with improved accuracy.

According to a second aspect of the invention, a method of monitoring an abnormality in an engine control unit that computes a required injection amount from a detected value of an engine operating condition, and drives an injector based on the required injection amount so as to control a fuel injection amount, includes the steps of determining whether the required injection amount was normally computed by the engine control unit, based on the required injection amount computed by the engine control unit, and the detected value of the engine operating condition used for computation of the required injection amount, and determining whether the injector was normally driven based on the required injection amount, based on the required injection amount computed by the engine control unit and a driven status of the injector.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram schematically illustrating the construction of an engine control unit to which a monitoring device according to a first embodiment of the invention is applied, and a fuel supply system of an engine controlled by the engine control unit;

FIG. 2 is a view illustrating the flow of operations associated with fuel injection control of the engine control unit to which the first embodiment is applied and monitoring of the computing function for the fuel injection control;

FIG. 3 is a flowchart illustrating a required injection amount monitored value calculating routine executed in the first embodiment of the invention;

FIG. 4 is a graph indicating the relationship between the engine speed Ne and accelerator operation amount Accp, and a required injection amount monitored value Qfinm;

FIG. 5 is a flowchart illustrating a first abnormality determining routine executed in the first embodiment;

FIG. 6 is a time chart indicating transitions of a crank angle signal, command signal, injection rate, and an injection monitor signal, and the timing of interrupts of each operation performed by the monitoring device, in the first embodiment;

FIG. 7 is a flowchart illustrating an injection amount monitored value calculating routine executed in the first embodiment;

FIG. 8 is a graph indicating the relationship between a current application monitored period INJM and an injection pressure Pcrinj, and an injection amount monitored value QM;

FIG. 9 is a flowchart illustrating a second abnormality determination routine executed in the first embodiment;

FIG. 10 is a flowchart illustrating an injection amount monitored value calculating routine executed in a second embodiment of the invention;

FIG. 11 is a flowchart illustrating a required injection amount monitored value calculating routine executed in a third embodiment of the invention; and

FIG. 12 is a graph indicating the relationship between the engine speed Ne and engine coolant temperature Thw, and a coolant temperature correction value Qthwcm.

### DETAILED DESCRIPTION OF EMBODIMENTS

### First Embodiment

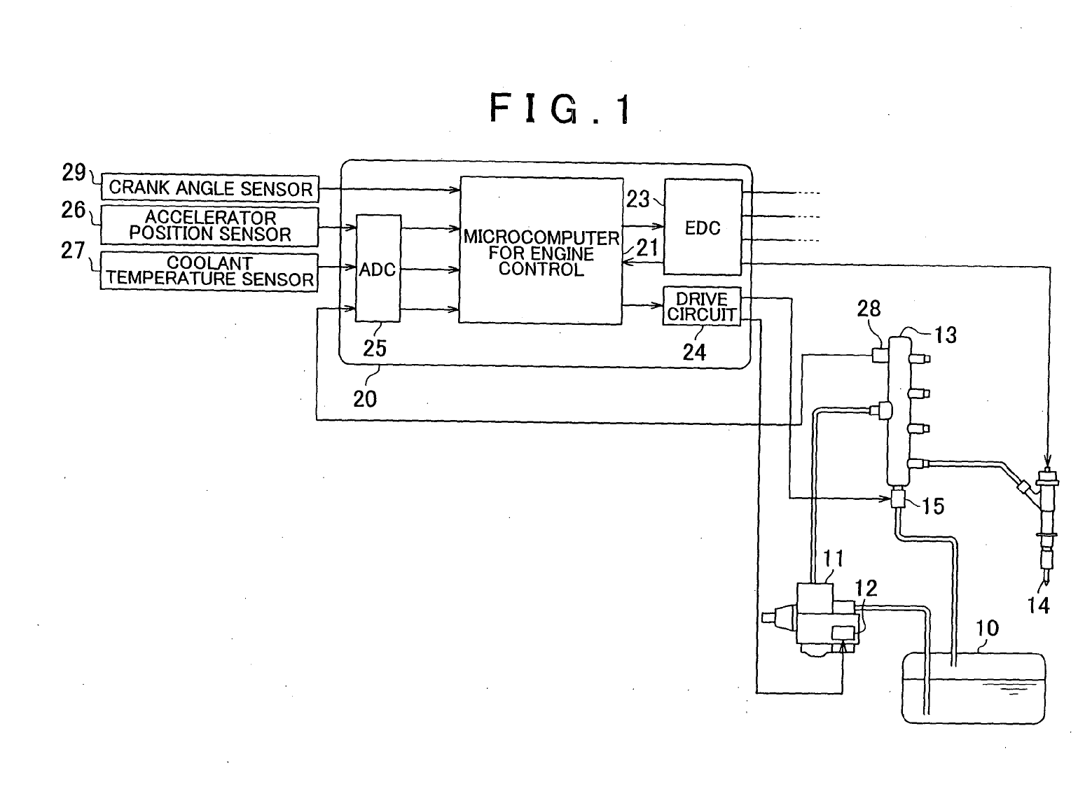

A monitoring device of an engine control unit according to a first embodiment of the invention will be described in detail with reference to FIG. 1 to FIG. 9. The monitoring device of this embodiment is applied to an engine control unit of a diesel engine installed on a vehicle.

Referring first to FIG. 1, the configuration of an engine control unit to which the monitoring device of this embodiment is applied, and a fuel supply system of the engine controlled by the engine control unit, will be described. As shown in FIG. 1, the fuel supply system of the engine to which the monitoring device of this embodiment is applied includes a fuel pump 11 that pressurizes and discharges fuel pumped up from a fuel tank 10. A pressure control valve (PCV) 12 for controlling the pressure of the fuel to be discharged is mounted in the fuel pump 11. The fuel delivered from the fuel pump 11 is fed under pressure to a common rail 13, and stored in the common rail 13. The fuel stored in the common rail 13 is distributed and supplied to injectors 14 of respective cylinders of the engine. The common rail 13 is provided with a pressure reducing valve 15 that returns the fuel within the common rail 13 to the fuel tank 10 so as to lower the pressure (rail pressure) of the fuel within the common rail 13.

The engine including the above fuel supply system is controlled by an engine control unit 20. The engine control unit 20 includes a microcomputer 21 that performs various computations in connection with engine control. The engine control unit 20 also includes an electronic drive unit (EDU) 23 that drives the injector 14 of each cylinder in response to a command from the microcomputer 21. The engine control unit 20 also includes a drive circuit 24 that drives the PCV 12 and the pressure reducing valve 15 in response to commands from the microcomputer 21.

Also, the engine control unit 20 receives detection signals from an accelerator position sensor 26, a coolant temperature sensor 27, a rail pressure sensor 28, a crank angle sensor 29, and so forth. The accelerator position sensor 26 detects the accelerator operation amount Accp. The coolant temperature sensor 27 detects the engine coolant temperature Thw. The rail pressure sensor 28 detects the rail pressure Pcr. The crank angle sensor 29 outputs a crank angle signal in the form of pulses according to rotation of an output shaft of the engine. An AD converter (ADC) 25 provided in the engine control unit 20 converts the detection signals of the accelerator position sensor 26, coolant temperature sensor 27, and the rail pressure sensor 28, into digital signals, which are then transmitted to the microcomputer 21. The crank angle signal generated from the crank angle sensor 29 is directly transmitted to the microcomputer 21.

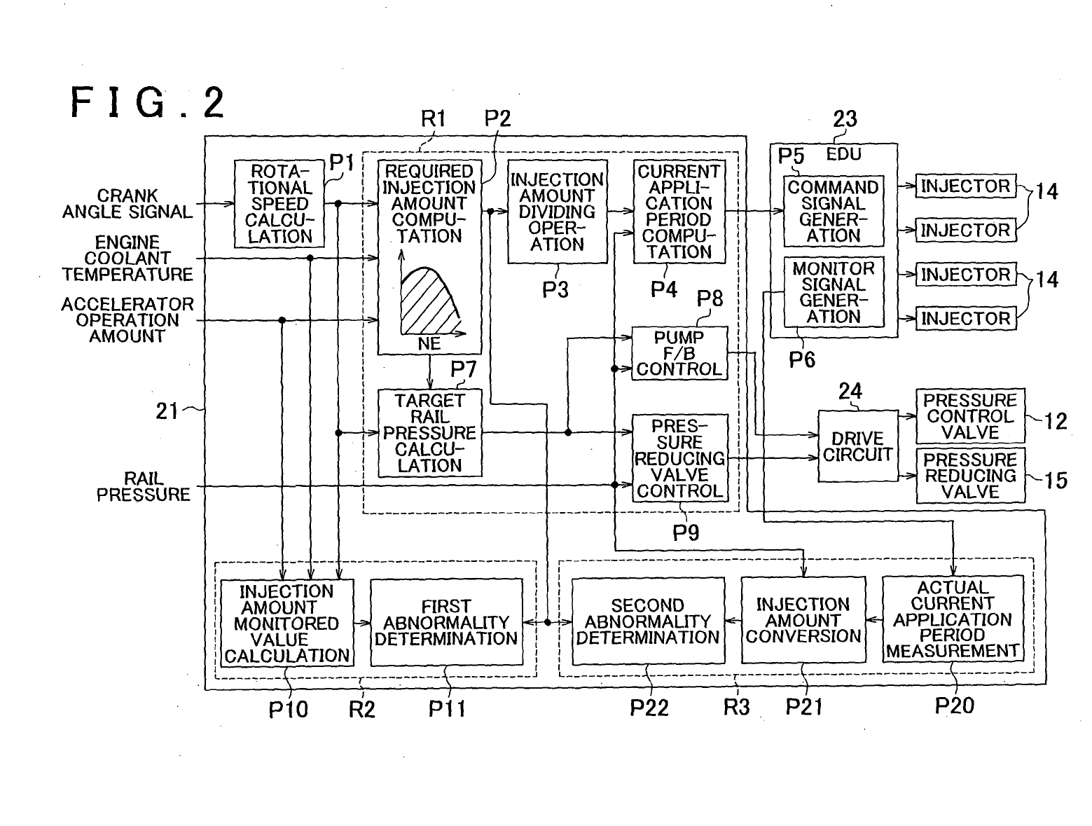

The engine control unit 20 constructed as described above performs control of the fuel injection amount, as one of engine controls. Next, the fuel injection amount control will be described in detail. As shown in FIG. 2, the microcomputer 21 performs operations of a fuel injection amount control routine R1. The fuel injection amount control routine R1 consists of required injection amount computation P2, injection amount dividing operation P3, and current application period computation P4.

In the required injection amount computation P2, the required injection amount Qfin is computed, based on the engine speed Ne, accelerator operation amount Accp, etc. In the process of computing the required injection amount Qfin, a base injection amount Qbse is initially calculated from the engine speed Ne and the accelerator operation amount Accp. The base injection amount Qbse is calculated based on a map for use in calculation of the base injection amount, which map is stored in the microcomputer 21. In this map, the relationship between the engine speed Ne and the accelerator operation amount Accp, and the base injection amount Qbse, is stored. The required injection amount Qfin is computed by correcting the thus computed base injection amount Qbse according to the engine coolant temperature Thw, etc.

The engine speed Ne is calculated in rotational speed calculation P1. In the rotational speed calculation P1, the engine speed Ne is calculated, based on a crank angle signal received from the crank angle sensor 29.

In the injection amount dividing operation P3, the required injection amount Qfin is distributed to respective injections, i.e., pilot injection, main injection, and after injection, and the injection amount of each injection is determined. The number of injections to which the required injection amount is distributed and the proportion of distribution of the injection amount among these injections are determined according to engine operating conditions detected at the time of the operation P3.

In the current application period computation P4, the current application period INJ of injector drive current for each injection is computed. The current application period INJ of each injection is determined based on the injection amount of each injection and the rail pressure Pcr. Then, the microcomputer 21 sends a command indicative of the computed current application period INJ of each injection, to the EDU 23.

The EDU 23 that has received the above command performs a command signal generating operation P5 to generate a command signal, based on the commanded current application period INJ of each injection. The command signal is generated such that its signal level rises to a level at which a solenoid valve of the injector 14 concerned can be opened at the same time that the current application period starts, and the signal level falls down to a level at which the solenoid valve cannot be held open at the same time that the current application period ends. The command signal thus generated is transmitted to the injector 14 of the corresponding cylinder.

The EDU 23 also performs a monitor signal generating operation P6 to detect current that flows through the solenoid valve of each injector 14, and generate an injection monitor signal from the result of detection. The injection monitor signal is generated as a pulse signal whose signal level is “High” during a period in which drive current is actually applied to the solenoid valve of the injector 14, and whose signal level is “Low” during a period in which no current is applied to the solenoid valve. The monitor signal thus generated is transmitted to the microcomputer 21.

Next, injection pressure control performed in association with the fuel injection amount control will be described. As shown in FIG. 2, the microcomputer 21 performs a target rail pressure calculation P7 for calculating a target rail pressure, based on the engine speed Ne calculated in the rotational speed calculation P1, and the required injection amount Qfin computed in the required injection amount computation P2. Then, the microcomputer 21 performs pump feedback (F/B) control P8 and pressure reducing valve control P9, based on the calculated target rail pressure, and the actual rail pressure Pcr detected by the rail pressure sensor 28.

In the pump F/B control P8, a target opening of the PCV 12 is computed according to a deviation or difference between the target rail pressure and the actual rail pressure Pcr. The computed target opening is transmitted to the drive circuit 24. Then, the drive circuit 24 drives the PCV 12 so as to provide the target opening, whereby the discharge pressure of the fuel pump 11 is controlled.

In the pressure reducing valve control P9, an operation command for operating the pressure reducing valve 15 is transmitted to the drive circuit 24, when the actual rail pressure Pcr is higher than the target rail pressure. When receiving the operation command, the drive circuit 24 operates the pressure reducing valve 15 so as to cause fuel to be discharged from the common rail 13, thereby to lower the rail pressure Pcr.

In the meantime, the microcomputer 21 constantly monitors whether the fuel injection amount control is normally performed, in parallel with the fuel injection amount control. In this embodiment, the monitoring of the fuel injection amount control is conducted through the following two monitoring routines. Namely, the fuel injection amount control is monitored by executing a first monitoring routine R2 for monitoring the function of the engine control unit 20 to compute the required injection amount Qfin, and a second monitoring routine R3 for monitoring the function of the engine control unit 20 to drive the injectors 14 based on the required injection amount Qfin.

The first monitoring routine R2 will be described in detail. In the first monitoring routine R2, it is determined whether the required injection amount Qfin was normally computed, based on a computed value of the required injection amount Qfin, and detected values (engine speed Ne, accelerator operation amount Accp) of engine operating conditions used for computation of the required injection amount Qfin. Namely, in this embodiment, a portion of the microcomputer 21 which executes the first monitoring routine R2 corresponds to the first abnormality determining unit according to the invention.

As shown in FIG. 2, the first monitoring routine R2 is performed through two operations, i.e., injection amount monitored value calculation P10, and first abnormality determination P11. In the injection amount monitored value calculation P10, the required injection amount (required injection amount monitored value Qfinm) is roughly estimated, based on the engine speed Ne and accelerator operation amount Accp used for computation of the required injection amount Qfin. In the first abnormality determination P11, it is determined whether the required injection amount Qfin was normally computed, by comparing the required injection amount monitored value Qfinm calculated in the injection amount monitored value calculation P10, with the required injection amount Qfin computed in the fuel injection amount control routine R1.

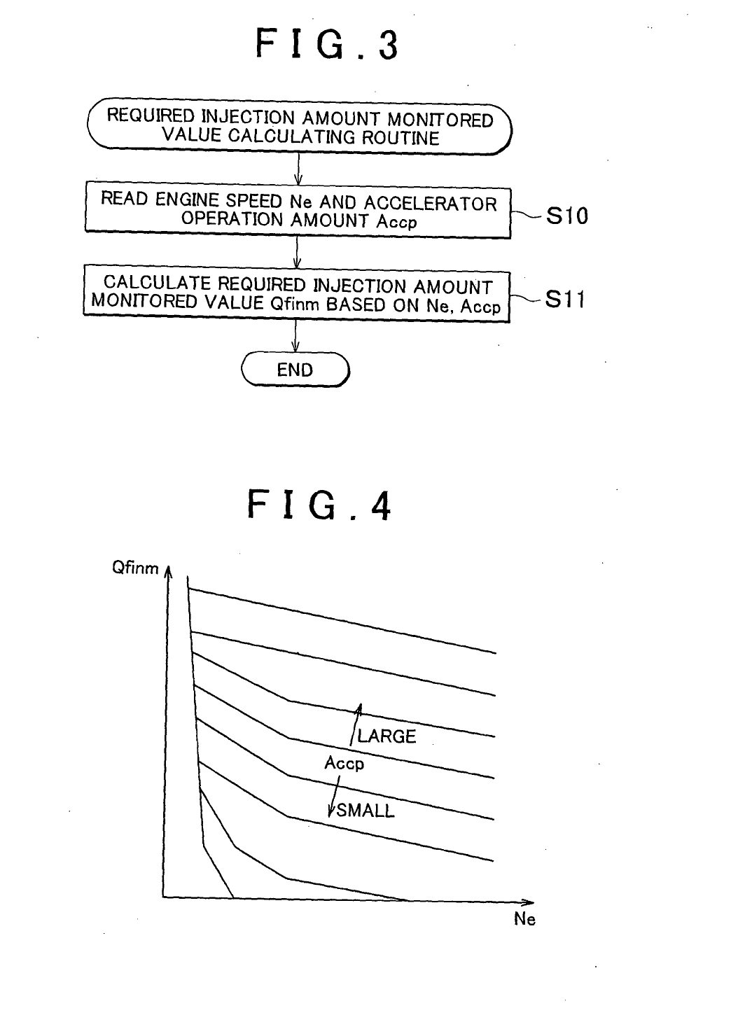

Next, the injection amount monitored value calculation P10 and the first abnormality determination P11 will be described in detail. The injection amount monitored value calculation P10 is performed through an injection amount monitored value calculating routine as shown in FIG. 3. The injection amount monitored value calculating routine is executed by the microcomputer 21 each time the required injection amount Qfin is computed.

As shown in FIG. 3, once this routine is started, the engine speed Ne and the accelerator operation amount Accp are read in step S10. In the following step S11, the required injection amount monitored value Qfinm is calculated, based on the read engine speed Ne and accelerator operation amount Accp, and then the current cycle of the routine of FIG. 3 ends.

The calculation of the required injection amount monitored value Qfinm in step Si 1 is conducted based on a map for use in calculation of the injection amount monitored value, which map is stored in the microcomputer 21. In this map, the relationship between the engine speed Ne and accelerator operation amount Accp, and the required injection amount monitored value Qfinm, as shown in FIG. 4, is stored. The relationship between the engine speed Ne and accelerator operation amount Accp, and the required injection amount monitored value Qfinm, in the map for use in calculation of the injection amount monitored value is identical with the relationship between the engine speed Ne and accelerator operation amount Accp, and the base injection amount Qbse, in the above-described map for use in calculation of the base injection amount (Qbse).

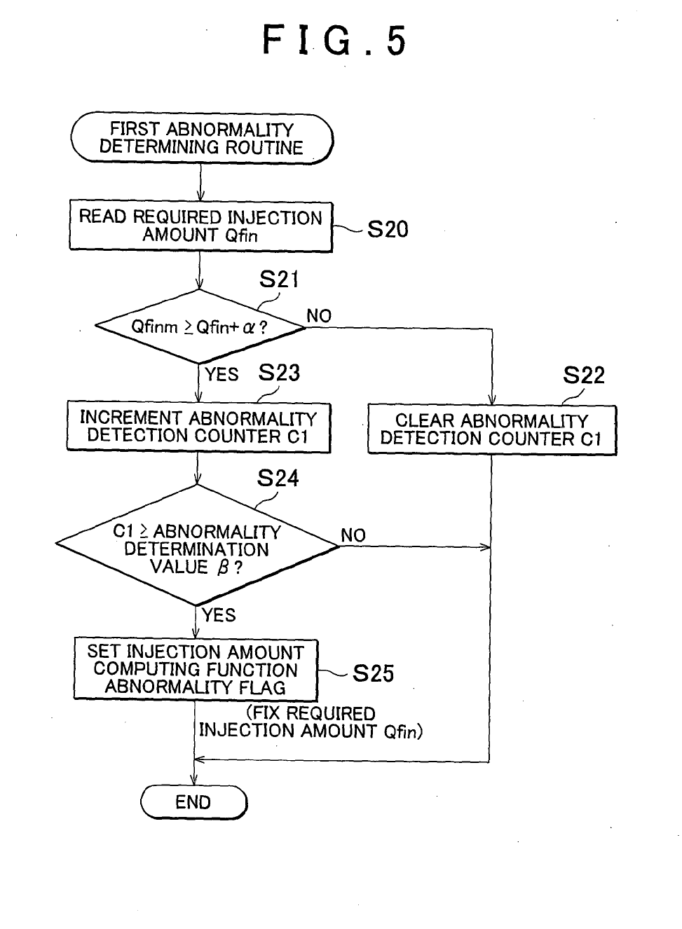

The first abnormality determining operation P11 is performed through a first abnormality determining routine as shown in FIG. 5. The first abnormality determining routine is executed by the microcomputer 21, subsequently to execution of the injection amount monitored value calculating routine.

As shown in FIG. 5, once this routine is started, the required injection amount Qfin computed in the fuel injection amount control routine R1 is read in step S20. In the following step S21, it is determined whether the required injection amount monitored value Qfinm calculated in the above-described injection amount monitored value calculation P10 deviates from the required injection amount Qfin. In this embodiment, an abnormality for which a fail-safe operation is needed is determined, when the required injection amount Qfin is larger than it should be, namely, when the amount of fuel to be injected is larger than it should be. Therefore, in this embodiment, it is determined that the deviation of the required injection amount monitored value Qfinm from the required injection amount Qfin appeared when the required injection amount monitored value Qfinm is larger by a predetermined value α or more than the required injection amount Qfin.

If it is determined that there is no deviation of the required injection amount monitored value Qfinm from the required injection amount Qfin (S21: NO), the control proceeds to step S22. In step S22, an abnormality detection counter C1 is cleared (i.e., its value is set to 0), and then the current cycle of the routine of FIG. 5 ends. The abnormality detection counter C1 indicates a duration for which the above-described deviation appears.

To the contrary, if it is determined that the required injection amount monitored value Qfinm deviates from the required injection amount Qfin (S21: YES), the control proceeds to step S23. In step S23, the abnormality detection counter C1 is incremented. In the following step S24, it is determined whether the abnormality detection counter C1 is equal to or larger than a specified abnormality determination value β. If the abnormality detection counter C1 is smaller than the abnormality determination value β (S24: NO), the current cycle of the routine of FIG. 5 ends.

On the other hand, if the abnormality detection counter C1 is equal to or larger than the abnormality determination value β (S24: YES), the control proceeds to step S25. After an injection amount computing function abnormality flag is set in step S25, the current cycle of the routine of FIG. 5 ends. When the injection amount computing function abnormality flag is set, the microcomputer 21 stops computing the required injection amount Qfin, and fixes its value, as a fail-safe operation.

Next, the second monitoring routine R3 will be described in detail. In the second monitoring routine R3, the amount (actual fuel injection amount) of fuel actually injected from the injectors 14 is compared with the required injection amount computed by the microcomputer 21, so that it is determined whether the injectors 14 were normally driven based on the computation result of the required injection amount Qfin. Namely, in this embodiment, a portion of the microcomputer 21 which executes the second monitoring routine R3 corresponds to the second abnormality determining unit according to the invention.

As shown in FIG. 2, the second monitoring routine R3 consists of three operations, i.e., actual current application period measurement P20, injection amount conversion P21, and second abnormality determination P22. In the actual current application period measurement P20, the period of application of drive current to the injectors 14 is measured, based on an injection monitor signal received from the EDU 23. In the injection amount conversion P21, the actual amount of fuel injected from the injectors 14 is calculated from the measured current application period. In the second abnormality determination P22, the calculated actual fuel injection amount is compared with the required injection amount Qfin calculated in the fuel injection amount control routine R1, so that it is determined whether the injectors 14 were normally driven based on the required injection amount Qfin.

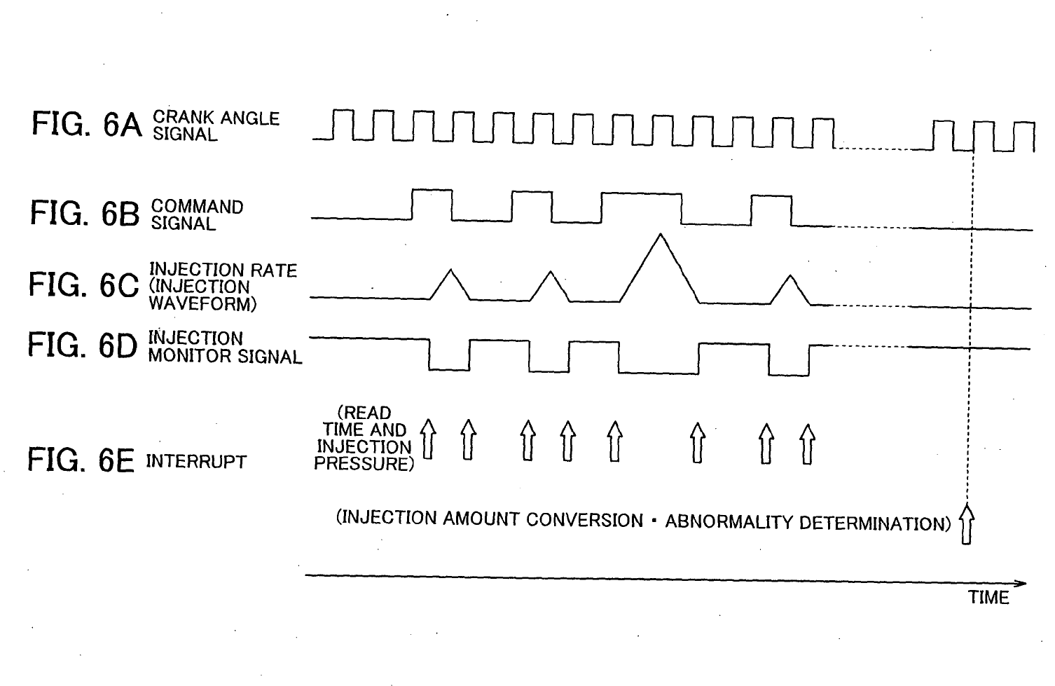

The actual current application period measurement P20 will be described in detail. FIG. 6 shows one example of transition of the crank angle signal, command signal, injection rate of the injector 14 concerned, and the injection monitor signal, when the fuel is injected. As shown in FIG. 6, if the signal level of the command signal generated from the EDU 23 to the injector 14 rises, the drive current that flows through the solenoid valve of the injector 14 increases to a level at which the solenoid valve can be opened, with a slight delay, and fuel injection is started. At the start of the fuel injection, the signal level of the injection monitor signal generated by the EDU 23 falls in response to the increase of the drive current. Subsequently, if the signal level of the command signal falls, the drive current stops being applied to the solenoid valve of the injector 14 with a slight delay, and the fuel injection from the injector 14 is stopped. At this time, the signal level of the injection monitor signal rises in response to stop of the application of the drive current.

As indicated by arrows representing interrupts of operations in FIG. 6, the microcomputer 21 takes in or reads times corresponding to the rises and falls of the injection monitor signal, as interrupt processing. Namely, the microcomputer 21 obtains start and ending times of each injection based on the injection monitor signal. Then, the microcomputer 21 calculates the period of application of the drive current in each injection, as a current application monitored period INJM.

In this embodiment, the microcomputer 21 takes in or reads the pressure (rail pressure Pcr) of the fuel supplied to the injector 14, at the same time that the start and ending times of each injection are read. In this embodiment, the rail pressure Pcr read at the ending time of each injection is obtained as the injection pressure Pcrinj of each injection.

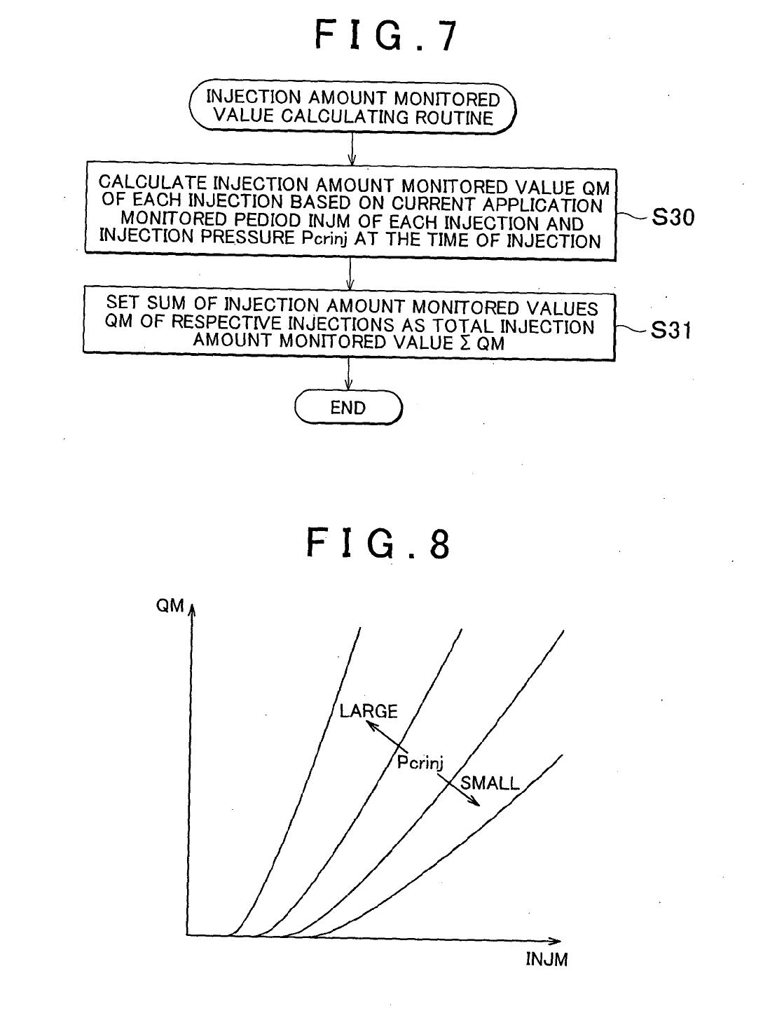

In this embodiment, the injection amount conversion P21 and the second abnormality determination P22 are carried out at a given point in time after completion of the fuel injection, as crank-angle interrupt processing. In the following, the injection amount conversion P21 will be described in detail. The injection amount conversion P21 is performed through an injection amount monitored value calculating routine as shown in FIG. 7. The routine of FIG. 7 is executed as a crank-angle interrupt operation, after completion of a series of fuel injections from the injector 14 concerned.

As shown in FIG. 7, once this routine is started, the injection amount of each injection is initially calculated as an injection amount monitored value QM in step S30, based on the current application monitored period INJM and injection pressure Pcrinj of each injection. In the microcomputer 21, a calculation map indicating the relationship between the current application period INJ and injection pressure Pcrinj, and the injection amount monitored value QM, as shown in FIG. 8, is stored. In step S30, the injection amount monitored value QM is calculated referring to the calculation map.

Subsequently, in step S31, the sum of the injection amount monitored values QM of respective injections is set as a total injection amount monitored value ΣQM. Then, the current cycle of the routine of FIG. 7 ends. The thus obtained total injection amount monitored value ΣQM indicates the total amount of fuel actually injected from the injector 14, in the series of fuel injections in the current cycle.

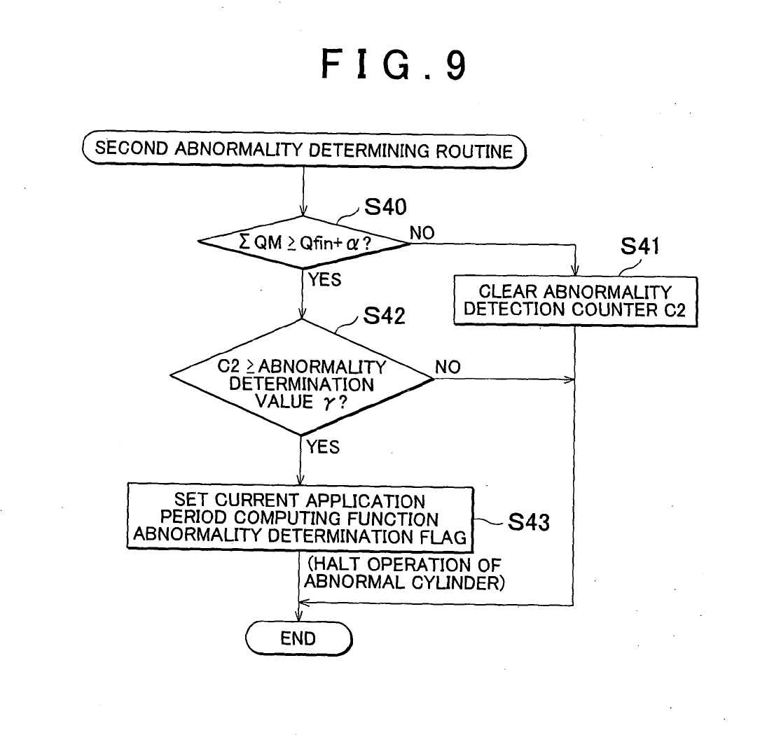

Next, the second abnormality determination P22 will be described in detail. The second abnormality determination P22 is performed through a second abnormality determination routine as shown in FIG. 9. The microcomputer 21 executes the routine of FIG. 9, subsequently to the injection amount monitored value calculating routine as described above.

As shown in FIG. 9, once this routine is started, it is initially determined whether the total injection amount monitored value ΣQM calculated in the injection amount conversion P21 deviates from the required injection amount Qfin computed in the fuel injection amount control routine R1. In this embodiment, an abnormality for which a fail-safe operation is needed is detected when the actual fuel injection amount is larger than it should be. In step 40, when the total injection amount monitored value ΣQM is larger by a predetermined value α or more than the required injection amount Qfin, it is determined that the total injection amount monitored value ΣQM deviates from the required injection amount Qfin.

If there is no deviation of the total injection amount monitored value ΣQM from the required injection amount Qfin (S40: NO), the control proceeds to step S41. After an abnormality detection counter C2 is cleared (i.e., its value is set to 0) in step S41, the current cycle of this routine ends. The value of the abnormality detection counter C2 is automatically incremented at given time intervals. Accordingly, the value of the abnormality detection counter C2 gradually increases as a condition where the total injection amount monitored value ΣQM deviates from the required injection amount Qfin continues.

On the other hand, if it is determined that the total injection amount monitored value ΣQM deviates from the required injection amount Qfin (S41: YES), the control proceeds to step S42. In step S42, it is determined whether the abnormality detection counter C2 is equal to or larger than a specified abnormality determination value γ. If the abnormality detection counter C2 is smaller than the abnormality determination value γ (S42: NO), the current cycle of this routine ends.

If, on the other hand, the abnormality detection counter C2 is equal to or larger than the abnormality determination value γ (S24: YES), the control proceeds to step S43. After a current application period computing function abnormality flag is set in step S43, the current cycle of this routine ends. If the current application period computing function abnormality flag is set, the microcomputer 21 halts operation of the cylinder to which an abnormality occurred, namely, stops injection of fuel into the cylinder, as a fail-safe operation.

The operation of this embodiment configured as described above will be described. In the engine control unit 20 to which this embodiment is applied, the microcomputer 21 computes the required injection amount Qfin based on the engine speed Ne, accelerator operation amount Accp, etc., and computes the period of application of drive current to each injector 14 based on the required injection amount Qfin, so as to control the fuel injection amount. Then, a command indicative of the computed current application period is sent to the EDU 23, and the EDU 23 causes drive current to be applied to the injector 14 according to the command.

In parallel with the above operation, the microcomputer 21 roughly estimates the required injection amount Qfin (calculates the required injection amount monitored value Qfinm), based on the engine speed Ne and accelerator operation amount Accp used for computation of the required injection amount Qfin. The microcomputer 21 determines whether the required injection amount Qfin was normally computed, by comparing the roughly estimated value with the required injection amount Qfin. If it is found, as a result of the determination, that the required injection amount Qfin is not normally computed by the microcomputer 21, the required injection amount Qfin is fixed or set to a fixed value as a fail-safe operation.

Also, the microcomputer 21 calculates the actual fuel injection amount (total injection amount monitored value ΣQM), based on the injection monitor signal generated according to the result of measurement of the drive current. By comparing the calculated value with the required injection amount Qfin, it is determined whether the injector 14 is normally driven based on the required injection amount Qfin. If it is found, as a result of the determination, that the injector 14 is not normally driven based on the required injection amount Qfin, the operation of the abnormal cylinder is halted, as a fail-safe operation.

The monitoring device of the engine control unit according to the embodiment as described above provides the following effects. In this embodiment, the microcomputer 21 determines whether the required injection amount Qfin was normally computed, based on the required injection amount Qfin computed in the fuel injection amount control routine R1, and the detected values (engine speed Ne, accelerator operation amount Accp) of the engine operating conditions used for computation of the required injection amount Qfin. Also, the microcomputer 21 determines whether the injector 14 was normally driven based on the required injection amount Qfin, based on the required injection amount Qfin computed in the fuel injection amount control routine R1, and the driven status (actual fuel injection amount) of the injector 14. Thus, in this embodiment, a series of operations of the engine control unit 20 associated with the fuel injection amount control are divided into two sets of operations, which are individually monitored. Therefore, even if the computation logic for monitoring is simplified, a computation error associated with each monitoring is reduced, and the abnormality detection accuracy is less likely to be or prevented from being deteriorated. Accordingly, the monitoring device of the engine control unit of this embodiment makes it possible to determine, with high accuracy, whether the fuel injection amount control is normally performed, without increasing the computational load.

In this embodiment, the fail-safe operation is performed in different manners, depending on whether an abnormality is detected in the first abnormality determination P11 or an abnormality is detected in the second abnormality determination P22. Therefore, the more appropriate fail-safe operation can be performed according to the type of the abnormality.

In this embodiment, the driven status of the injector 14 is determined from the measurement results of the current application period of the injector drive current, and an abnormality is determined in the second abnormality determination routine. Therefore, the presence or absence of an abnormality in the function of the microcomputer 21 to compute the current application period, and the presence or absence of an abnormality in the function of the EDU 23 to produce the drive current, can be both determined.

In this embodiment, the acquisition or reading of the start and ending times of application of the injector drive current, and the determination of an abnormality and computation for the determination, are carried out at different points in time. Thus, the operations are separated or spaced in time from each other, so that the peak load of the microcomputer 21 can be reduced.

In this embodiment, an abnormality in the function of the microcomputer 21 to compute the current application period is determined, using the pressure (rail pressure Pcr) of the fuel supplied to the injector 14. Therefore, an abnormality determination, taking account of changes in the current application period due to the rail pressure Pcr, can be made, thus assuring high abnormality determination accuracy.

In this embodiment, the pressure (rail pressure Pcr) of the fuel supplied to the injector 14 is obtained at the same time that the start and ending times of application of the injector drive current are obtained. Therefore, the number or frequency of interrupts in processing for obtaining data can be prevented from increasing, and other operations are less likely to be or prevented from being delayed due to the interrupts.

### Second Embodiment

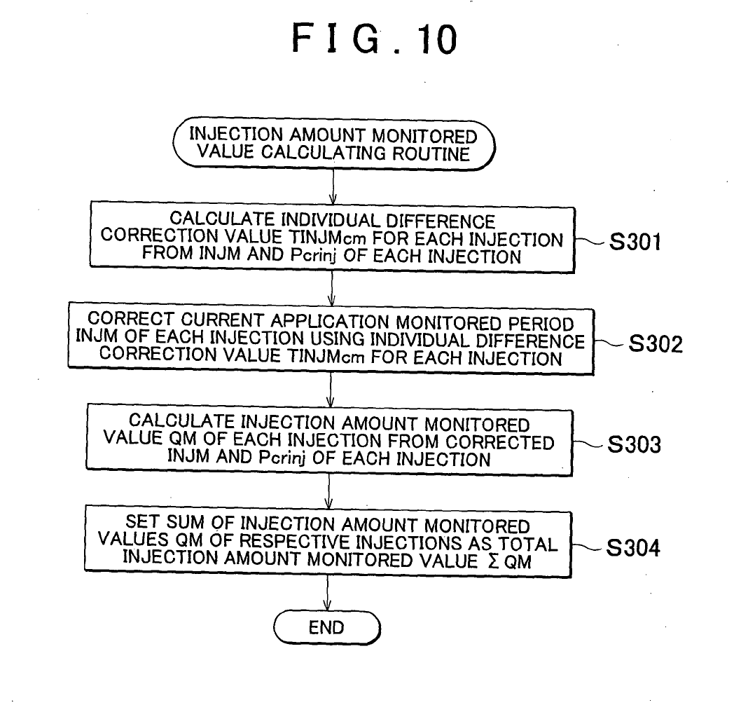

Next, a second embodiment of the invention will be described with reference to FIG. 10. In this embodiment and a third embodiment (which will be described later), the same reference numerals are assigned to the same or corresponding components or units as those of the first embodiment, and these components or units will not be described in detail.

There are individual differences in injection characteristics of the injectors 14, and the amount of fuel injected during a given period of application of drive current varies from one injector 14 to another. Therefore, the current application period may be corrected in terms of individual differences among the injectors 14, so that the fuel injection amount can be accurately controlled, irrespective of the individual differences in the injection characteristics of the injectors 14.

In this embodiment, the current application period is corrected in terms of individual differences in the following manner. The injection characteristics of the respective injectors 14 are measured before the injectors 14 are mounted in the engine, and correction data for each of the injectors 14 is created from the measurement results. In the correction data, a correction amount of current application period, which is required to compensate for individual differences in the injection characteristics, is recorded for each current application period and each rail pressure Pcr. The correction data is stored in the microcomputer 21 when the injectors 14 are mounted in the engine. The correction data in the form of a matrix-type two-dimensional code, or the like, is attached to each of the injectors 14, and is read with a scanner when the injector 14 is mounted in the engine.

In the current application period computation P4, the microcomputer 21 computes the current application period of each injection, based on the injection amount and rail pressure Pcr of each injection, and calculates an individual difference correction value for each injection from the current application period and rail pressure Pcr of each injection, referring to the correction data. Then, the microcomputer 21 corrects the current application period of each injection, using the calculated individual difference correction value.

In the above case, the computation result of the current application period obtained in the fuel injection amount control routine R1 includes a correction amount corresponding to the individual difference correction value. If the microcomputer 21 calculates the total injection amount monitored value ΣQM in the injection amount conversion P21, without taking account of the correction amount, a deviation corresponding to the individual difference correction amount appears between the total injection amount monitored value ΣQM and the required injection amount Qfin, even if the engine control unit 20 adequately computes the current application period. Thus, in this embodiment, the microcomputer 21 makes a determination in the second monitoring routine R3, taking account of the individual difference correction value for compensating for the individual differences in the injection characteristics of the injectors 14, thus assuring high determination accuracy.

In this embodiment, the injection amount conversion P21 is performed, through an injector amount monitored value calculating routine as shown in FIG. 10. The routine of FIG. 10 is executed by the microcomputer 21 as a crank-angle interrupt routine, after completion of a series of fuel injections from the injector 14 concerned.

As shown in FIG. 10, once this routine is started, an individual difference correction value TINJMcm for each injection is initially calculated in step S301, based on the current application monitored period INJM and injection pressure Pcrinj of each injection. In this step, the individual difference correction value TINJMcm is calculated with reference to the above-mentioned correction data.

Subsequently, in step S302, the current application monitored period INJM of each injection is corrected, using the calculated individual difference correction value TINJMcm for each injection. Then, in step S303, the injection amount monitored value QM of each injection is calculated, based on the corrected current application monitored period INJM and injection pressure Pcrinj of each injection. The calculation of the injection amount monitored value QM in this step is conducted substantially in the same manner as that of the first embodiment.

In step S304, the sum of the injection amount monitored values QM of the respective injections is set as a total injection amount monitored value ΣQM. Then, the current cycle of this routine ends. Next, the operation of this embodiment will be described. In this embodiment, individual difference correction amounts of the current application periods INJ commensurate with individual differences in the injection characteristics of the injectors 14 are reflected in the calculation of the actual fuel injection amount (total injection amount monitored value ΣQM) based on the measurement results of the current application periods of the injector drive current in the injection amount conversion P21. Therefore, even when the individual difference correction amounts of the current application periods INJ are large, the actual fuel injection amount can be adequately obtained, and an abnormality determination is adequately made in the second abnormality determination P22.

The monitoring device of the engine control unit according to the embodiment as described above provides the following effect, in addition to the effects as described above with respect to the first embodiment. In the second embodiment, the individual difference correction values for compensating for individual differences in the injection characteristics of the injectors 14 are used in the determination of an abnormality in the function of computing the current application periods. More specifically, correction using the individual difference correction value is applied to calculation of the actual fuel injection amount (the injection amount monitored value QM), based on the measurement result of the period for which the drive current is applied to the injector 14 concerned. Therefore, an abnormality can be determined with high accuracy, irrespective of changes in the current application period depending on the individual differences.

### Third Embodiment

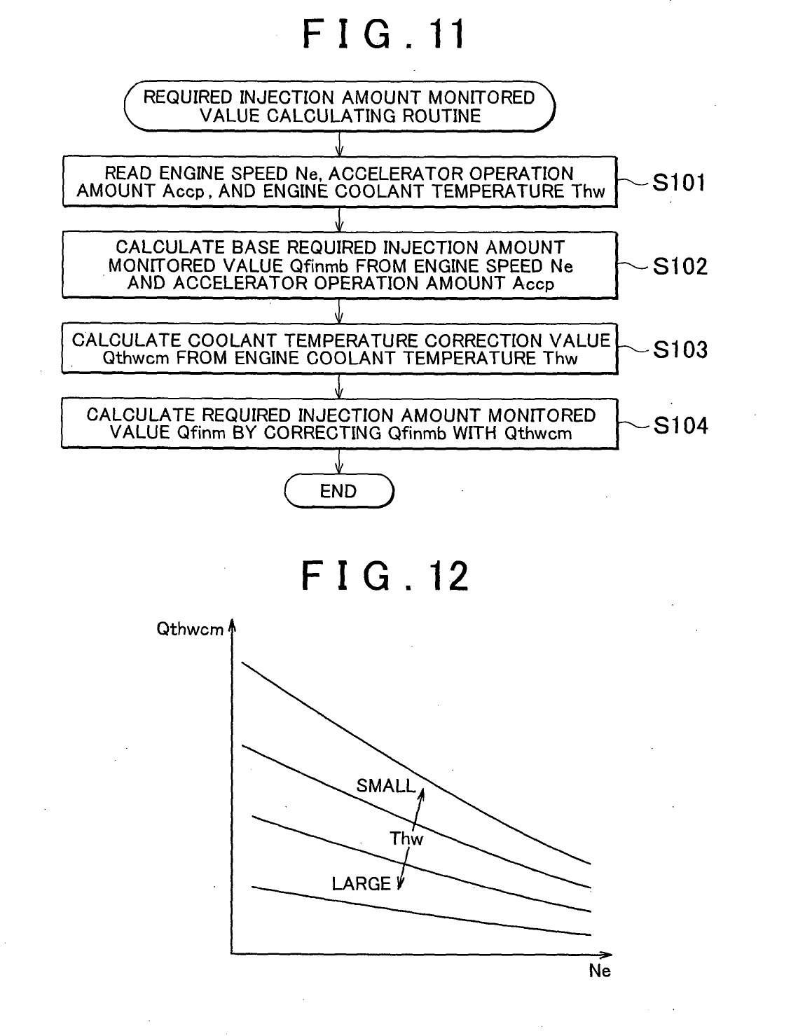

Next, the third embodiment of the invention will be described with reference to FIG. 11. As described above, in the calculation of the required injection amount Qfin, correction (coolant-temperature correction) in terms of the engine coolant temperature Thw is conducted. On the other hand, when the required injection amount Qfin is roughly estimated (i.e., when the required injection amount monitored value Qfinm is calculated) in the first monitoring routine R2 in the first embodiment, a correction amount associated with the coolant temperature is not taken into consideration. Therefore, even when the microcomputer 21 adequately calculates the required injection amount Qfin, a deviation or difference between the required injection amount Qfin and the required injection amount monitored value Qfinm becomes large if the correction amount associated with the coolant temperature is large, and an abnormality determination may not be appropriately made. Thus, in this embodiment, the microcomputer 21 makes a determination in the first monitoring routine R2, referring to the engine coolant temperature Thw, so as to ensure high abnormality determination accuracy.

In this embodiment, the injection amount monitored value calculation P10 is performed through a required injection amount monitored value calculating routine as shown in FIG. 11. The routine of FIG. 11 is executed by the microcomputer 21 each time the required injection amount Qfin is computed in the fuel injection amount control routine R1.

As shown in FIG. 11, once this routine is started, the engine speed Ne, accelerator operation amount Accp, and the engine coolant temperature Thw are read in step S101. In the following step S102, the base required injection amount monitored value Qfinmb is calculated, based on the read engine speed Ne and accelerator operation amount Accp. The calculation of the base required injection amount monitored value Qfinmb in step S102 is conducted in substantially the same manner as the calculation of the required injection amount monitored value Qfinm in step S11 of the required injection amount calculating routine of the first embodiment.

In the following step S103, a coolant temperature correction value Qthwcm is calculated based on the engine coolant temperature Thw. The coolant temperature correction value Qthwcm is calculated with reference to a calculation map stored in the microcomputer 21. In the calculation map, the relationship between the engine speed Ne and engine coolant temperature Thw, and the coolant temperature correction value Qthwcm, as shown in FIG. 12, is stored. This calculation map is similar to a map used for correcting the required injection amount Qfin in terms of the coolant temperature in the required injection amount computation P2 of the fuel injection amount control routine R1. In step S104, the required injection amount monitored value Qfinm is calculated by correcting the base required injection amount monitored value Qfinmb with the coolant temperature correction value Qthwcm. Then, the current cycle of this routine ends.

Next, the operation of this embodiment will be described. In this embodiment, a coolant temperature correction amount of the required injection amount Qfin commensurate with the engine coolant temperature Thw is reflected in the calculation of the required injection amount monitored value Qfinm in the injection amount monitored value calculation P10. Therefore, the required injection amount monitored value Qfinm is adequately obtained even if the coolant temperature correction amount is large, and an abnormality determination is adequately made in the first abnormality determination P11.

The monitoring device of the engine control unit according to the embodiment as described above provides the following effect, in addition to the effects as described above with respect to the first embodiment. In the third embodiment, an abnormality in the function of computing the required injection amount is determined referring to the engine coolant temperature Thw. More specifically, the required injection amount based on detected values of the engine operating conditions used for calculation of the required injection amount Qfin in the fuel injection amount control routine R1 is roughly estimated (i.e., the required injection amount monitored value Qfinm is calculated), referring to the engine coolant temperature Thw, in addition to the engine speed Ne and the accelerator operation amount Accp. Therefore, an abnormality can be determined with high accuracy, irrespective of changes in the required injection amount Qfin due to variations in the coolant temperature.

Each of the illustrated embodiments may be modified as follows. In the illustrated embodiments, the pressure (injection pressure Pcrinj) of the fuel supplied to the injector 14 is acquired or read at the same time that the start and ending times of application of drive current to the injector 14 are acquired or read. However, the injection pressure Pcrinj may be acquired at a point in time different from the time when the start and ending times of current application are acquired.

In the illustrated embodiments, the computation of the current application period in the actual current application period measurement P20, calculation of the total injection amount monitored value ΣQM in the injection amount conversion P21, and determination in the second abnormality determination P22 are carried out at different times from the times at which the start and ending times of application of the drive current to the injector 14 are acquired or read. Namely, determination of an abnormality in the function of computing the current application period and computation for making the determination are carried out at different times from the times at which the start and ending times of the current application period are acquired. If the microcomputer 21 has sufficiently high computing capability, the acquisition of the start and ending times, determination of an abnormality, and computation for the determination may be carried out in parallel or simultaneously.

While an abnormality is detected only when the actual fuel injection amount is larger than it should be in the illustrated embodiments, an abnormality may also be detected as needed when the actual fuel injection amount is smaller than it should be. For example, such an abnormality determination may be made by determining, in step S21 of FIG. 5, whether an absolute value of a difference between the required injection amount Qfin and the required injection amount monitored value Qfinm is equal to or larger than the predetermined value α, and determining, in step S40 of FIG. 9, whether an absolute value of a difference between the required injection amount Qfin and the total injection amount monitored value ΣQM is equal to or larger than the specified value α.

In the illustrated embodiments, the microcomputer 21 roughly estimates the required injection amount (calculates the required injection amount monitored value Qfinm), based on detected values (engine speed Ne, accelerator operation amount Accp, etc.) of the engine operating conditions used for computation of the required injection amount Qfin in the fuel injection amount control routine R1. Then, the microcomputer 21 determines whether the required injection amount Qfin was normally computed, by comparing the required injection amount Qfin computed in the fuel injection amount control routine R1 with the roughly estimated value thereof (the required injection amount monitored value Qfinm). A similar determination may be made by inversely calculating the detected values of the engine operating conditions used for computation of the required injection amount Qfin, from the required injection amount Qfin, and comparing them with the detected values of the engine operating conditions actually used for computation of the required injection amount Qfin in the fuel injection amount control routine R1. For example, a similar determination may be made by estimating the accelerator operation amount Accp used for computation of the required injection amount Qfin, based on the required injection amount Qfin and the engine speed Ne, in the first monitoring routine R2, hand determining whether the estimated value coincides with the accelerator operation amount Accp actually used.

In the illustrated embodiments, it is determined whether the injector 14 was normally driven based on the required injection amount Qfin, by obtaining the actual fuel injection amount (total injection amount monitored value ΣQM) from the measurement results (injection monitor signal) of the periods for which the drive current is applied to the injector 14, and comparing the actual fuel injection amount (ΣQM) with the required injection amount Qfin. If the actual fuel injection amount can be obtained with sufficiently high accuracy, engine torque produced by combustion of the injected fuel may be obtained from the amount of change in the engine speed Ne after the injection, for example, and the above determination may be made by obtaining the actual fuel injection amount from the engine torque.

The actual fuel injection amount (total injection amount monitored value ΣQM) may be calculated from the current application periods computed by the microcomputer 21, in place of the measurement results (injection monitor signal) of the periods for which the drive current is applied to the injector 14. In this case, it is determined in the second monitoring routine R3 whether the current application period was normally computed by the microcomputer 21, based on the required injection amount Qfin.

In the illustrated embodiments, an abnormality in the function of the microcomputer 21 to compute the current application period is determined, by comparing the actual fuel injection amount with the required injection amount Qfin. A similar abnormality determination may be made by estimating the period for which the drive current is applied to the injector 14, from the required injection amount Qfin computed in the fuel injection amount control routine R1, and comparing the estimated value with the current application period computed in the fuel injection amount control routine R1.

In the illustrated embodiments, the required injection amount Qfin is fixed, as a fail-safe operation, when an abnormality is found in the function of computing the required injection amount, and operation of an abnormal cylinder is halted, as a fail-safe operation, when an abnormality is found in the function of computing the current application period. However, the contents of the fail-safe operations may be changed. Also, the same fail-safe operation may be performed no matter which abnormality is found.

While the microcomputer 21 performs computations associated with the fuel injection amount control, and performs operations for monitoring the control, in the illustrated embodiments, these computations and operations may be separately performed by different microcomputers. The first monitoring routine R2 and the second monitoring routine R3 may be performed by different microcomputers.

While the monitoring device for monitoring an abnormality in fuel injection control is incorporated in the engine control unit 20 in the illustrated embodiments, such a monitoring device may be provided outside the engine control unit 20. Namely, the first monitoring routine R2 and the second monitoring routine R3 may be performed by a monitoring device provided outside the engine control unit 20.

1-9. (canceled)

10. A monitoring device for monitoring an abnormality in an engine control unit that computes a required injection amount from a detected value of an engine operating condition, and drives an injector based on the required injection amount so as to control a fuel injection amount, the monitoring device comprising:
a microcomputer configured to perform a first abnormality determination as to whether the required injection amount is normally computed by the engine control unit, based on the required injection amount computed by the engine control unit, and the detected value of the engine operating condition used for computation of the required injection amount; and
the microcomputer configured to perform a second abnormality determination as to whether the injector is normally driven based on the required injection amount, based on the required injection amount computed by the engine control unit and a driven status of the injector.

11. The monitoring device according to claim 10, wherein
in an engine to which the monitoring device is applied, the microcomputer is configured to perform a fail-safe operation in a first manner when an abnormality is detected in the first abnormality determination, and a fail-safe operation in a second manner different from the first manner when an abnormality is detected in the second abnormality determination.

12. The monitoring device according to claim 10, wherein
the microcomputer is configured to obtain the driven status of the injector from a measurement result of a current application period for which drive current is applied to the injector, so as to make the determination in the second abnormality determination.

13. The monitoring device according to claim 12, wherein
the microcomputer is configured to acquire start and ending times of application of the drive current, respectively, so as to make the determination in the second abnormality determination, and makes the determination and performs computation for the determination in the second abnormality determination, at different points in time from points in time at which the start and ending times are acquired.

14. The monitoring device according to claim 12, wherein
the engine control unit is configured to compute the current application period while making correction according to a pressure of fuel supplied to the injector, and
the microcomputer is configured to make the determination in the second abnormality determination, referring to the pressure of the fuel.

15. The monitoring device according to claim 14, wherein
the microcomputer is configured to acquire start and ending times of application of the drive current, respectively, so as to make the determination in the second abnormality determination, and acquired the pressure of the fuel at the same time that either of the start and ending times of current application is acquired.

16. The monitoring device according to claim 12, wherein
the engine control unit is configured to compute the current application period while making correction using an individual difference correction value for compensating for an individual difference in an injection characteristic of the injector,
and the microcomputer is configured to refer to the individual difference correction value when making the determination in the second abnormality determination.

17. The monitoring device according to claim 10, wherein
the engine control unit is configured to compute the required injection amount while making correction in terms of an engine coolant temperature, and
the microcomputer is configured to refer to the engine coolant temperature when making the determination in the first abnormality determination.

18. The monitoring device according to claim 10, wherein
the engine control unit includes the microcomputer.

19. The monitoring device according to claim 10, wherein
the microcomputer is provided outside the engine control unit.

20. A monitoring device for monitoring an abnormality in the engine control unit that computes a required injection amount from a detected value of an engine operating condition, and drives an injector based on the required injection amount so as to control a fuel injection amount, the monitoring device comprising:
first abnormality determining means for making a determination as to whether the required injection amount was normally computed by the engine control unit, based on the required injection amount computed by the engine control unit, and the detected value of the engine operating condition used for computation of the required injection amount; and
second abnormality determining means for making a determination as to whether the injector is normally driven based on the required injection amount, based on the required injection amount computed by the engine control unit and a driven status of the injector.

21. A method of monitoring, by a monitoring device, an abnormality in an engine control unit that computes a required injection amount from a detected value of an engine operating condition, and drives an injector based on the required injection amount so as to control a fuel injection amount, the method comprising:
determining, by the monitoring device, whether the required injection amount is normally computed by the engine control unit, based on the required injection amount computed by the engine control unit, and the detected value of the engine operating condition used for computation of the required injection amount; and
determining, by the monitoring device, whether the injector is normally driven based on the required injection amount, based on the required injection amount computed by the engine control unit and a driven status of the injector.
